(19) United States
(12) Patent Application Publication
(10) Pub. No.: US 2008/0277980 A1
(43) Pub. Date: Nov. 13, 2008

(54) SEAT RAIL STRUCTURE OF MOTORCYCLE

(76) Inventors: Toshihiro KODA, Saitama (JP); Junichi Ueda, Saitama (JP); Shinsuke Mochizuki, Saitama (JP); Yohei Kawasaki, Saitama (JP)

Correspondence Address: BIRCH STEWART KOLASCH & BIRCH, PO BOX 747, FALLS CHURCH, VA, 22040-0747, US

(21) Appl. No.: 12/036,873

(22) Filed: Feb. 25, 2008

(30) Foreign Application Priority Data
Feb. 28, 2007 (JP) 2007-048655

(51) Int. Cl. B62J 1/08

(52) U.S. Cl. 297/215.16

(57) ABSTRACT

A seat rail structure for a motorcycle having sufficient strength and rigidity while achieving a weight reduction of a vehicle body. A seat rail structure of a motorcycle includes a main frame and a seat rail formed of magnesium alloy to be secured to the main frame. The seat rail includes a pair of left and right side wall portions extending rearwardly from the main frame, and a plurality of connecting portions formed into a substantially angular C-shape in cross section or into a substantially H-shape in cross section for connecting the left and right side wall portions. At least part of the connecting portions are connected at a level flush with or above the upper surface of the side wall portions. The side wall portions and the connecting portions are integrally formed by die casting.

### CROSS-REFERENCE TO RELATED APPLICATIONS

The present application claims priority under 35 USC 119 to Japanese Patent Application No. 2007-048655 filed on Feb. 28, 2007 the entire contents of which are hereby incorporated by reference.

### BACKGROUND OF THE INVENTION

1. Field of the Invention

The present invention relates to a seat rail structure of a motorcycle for supporting a seat on which a passenger sits.

2. Description of Background Art

In the related art, a frame of a motorcycle is formed of iron-based material because it is easy to work and is inexpensive. However, in recent years, vehicle body frames formed of light metal such as aluminum or magnesium as raw material are employed for achieving a weight reduction of the vehicle body. Therefore, seat rails for supporting a seat formed of aluminum by die casing are currently being employed. See, for example, JP-A-2004-98875.

The seat rail disclosed in JP-A-2004-98875 has a structure in which the frames positioned on the left and right are separated and the left and right frames are secured by tightening members via the cross members or the like.

The configuration in the related art is preferably in that the seat rails are easily manufactured not by welding or the like but by securing them by the tightening members. However, in the structure of securing by the tightening members, an assembly process is required. Thus, it is difficult to improve the productivity.

When magnesium alloy is employed for the vehicle body frame, it is difficult to manufacture frames having high corrosion resistance while securing sufficient strength and rigidity.

### SUMMARY AND OBJECTS OF THE INVENTION

In view of such circumstances, it is an object of an embodiment of the present invention to provide a seat rail structure of a motorcycle which further improves the productivity. In addition, a seat rail structure of a motorcycle is provided in which a sufficient strength and rigidity are secured while achieving a weight reduction of the vehicle body. Furthermore, a seat rail structure for a motorcycle is provided that is also superior in corrosion resistance.

According to an embodiment of the present invention, a seat rail structure for a motorcycle is provided that includes a main frame and a seat rail formed of a magnesium alloy to be secured to the main frame. The seat rail includes a pair of left and right side wall portions extending rearwardly from the main frame, and a plurality of connecting portions formed into a substantially angular C-shape in a cross section or into a substantially H-shape in a cross section for connecting the left and right side wall portions. At least a part of the connecting portions are connected at a level flush with or above the upper surface of the side wall portions with the side wall portions and the connecting portions being integrally formed by die casting.

In this configuration, the seat rail is formed by die casting integrally without using tightening members. It is also possible to secure a clearance for allowing the up and down movement of a rear wheel arranged below the seat rail. In addition, a sufficient strength and rigidity are secured while achieving weight reduction of the connecting portions.

Further, a configuration is provided in which the side wall portion is formed at the upper end thereof with an upper flange portion extending inwardly in the direction of the width of the seat rail along the longitudinal direction of the side wall portion and having a first flange portion extending downwardly from the distal end thereof. At the lower end thereof, with a lower flange portion extending outwardly in the direction of the width of the seat rail along the longitudinal direction of the side wall portion, a second flange portion is provided that extends upwardly from the distal end thereof.

In this configuration, sufficient strength and rigidity are secured while achieving a weight reduction of the left and right side wall portions.

It is also possible to provide a first rib to the connecting portions so as to extend in the longitudinal direction at the center of the substantially angular C-shaped cross section or the substantially H-shaped cross section thereof.

In this configuration, the flexural strength and rigidity of the connecting portion are improved.

It is also possible to provide a second rib for connecting at least one of the upper flange portion and the lower flange portion with the side wall portions.

In this configuration, the strength of the connecting portions between the upper flange portion or the lower flange portion and the side wall portions is improved.

On the other hand, the magnesium alloy of AM50A or AM60B, and AM50A or AM60B may include rare earths added by 0.2 wt % to 0.5 Wt %.

In this configuration, corrosion resistance of the seat rail is improved.

On the other hand, the magnesium alloy of AM50A or AM60B, and AM50A or AM60B may include rare earths added by 2.0 wt % to 5.0 Wt %.

In this configuration, corrosion resistance is improved and the strength and rigidity at elevated temperature are simultaneously improved.

According to an embodiment of the present invention, there is provided a seat rail structure for a motorcycle including a main frame and a seat rail formed of magnesium alloy to be secured to the main frame. The seat rail includes a pair of left and right side wall portions extending rearwardly from the main frame, and a plurality of connecting portions formed into a substantially angular C-shape in cross section or into a substantially ft-shape in cross section for connecting the left and right side wall portions. At least a part of the connecting portions are connected at a level flush with or above the upper surface of the side wall portions with the side wall portions and the connecting portions being integrally formed by die casting. Therefore, it is not necessary to assemble the seat rail with the tightening members. Thus, the productivity of the seat rail is improved. Since the entire seat rail is formed of an magnesium alloy, the weight reduction of the vehicle body is achieved. Since at least part of the connecting portions are connected at a level flush with or the upper surface of the side wall portions, an interference between a rear wheel and the connecting portions of the seat rail is avoided when the rear wheel is arranged below and the seat rail moves up and down. Furthermore, since the coefficient of the cross section can be increased by forming the connecting portions into the substantially angular C-shape in cross section or in the substantially H-shape in cross section, a sufficient strength and rigidity with respect to the bending or tensile load of the connecting portions and are secured.

The side wall portion is formed at the upper end thereof with an upper flange portion extending inwardly in the direction of the width of the seat rail along the longitudinal direction of the side wall portion and having a first flange portion extending downwardly from the distal end thereof. At the lower end thereof a lower flange portion extends outwardly in the direction of the width of the seat rail along the longitudinal direction of the side wall portion and includes a second flange portion extending upwardly from the distal end thereof. Therefore, in comparison with the structure in which the left and right side wall portions are solid, a weight reduction of side wall portions is achieved. Since the coefficient of the cross section of the side wall portions is increased, a sufficient strength and rigidity are secured for bending or tensile load of the side wall portions. Consequently, the strength of the entire seat rail is improved.

Since a first rib extending in the longitudinal direction is provided at the center of the substantially angular C-shaped cross section or the substantially H-shaped cross section of the connecting portions, the flexural strength and rigidity of the connecting portion are further improved. Consequently, the strength of the entire seat rail is further improved.

Since second ribs are provided so as to connect at least one of the upper flange portions and the lower flange portions with the side wall portions, the strength and rigidity of the connecting portions between the upper flange portions or the lower flange portions and the side wall portions are improved. Consequently, the strength of the entire seat rail is improved.

Since the magnesium alloy is AM50A or AM60B, and the rare earths include the AM50A or AM60B added by 0.2 wt % to 0.5 wt %, the corrosion resistance of the seat rail is improved. Consequently, the number of times required for a coating application for the surface processing is reduced or an application of a less-expensive surface processing is possible when applying the surface processing for corrosion resistance on the surface of the seat rail. Therefore, the number of processes of the manufacturing of the seat rail is reduced. Thus, the productivity is improved.

Since the magnesium alloy is AM50A or AM60B, and the rare earths are added to the AM50A or AM60B by 2.0 wt % to 5.0 wt %, the corrosion resistance is improved, and the strength at elevated temperature is simultaneously improved. The rare earths improve toughness required for the frame in comparison with other high temperature strength improving additives (Ca, Sr, etc.).

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a left side view showing a motorcycle according to an embodiment of the present invention;

FIG. 2 is a left side view showing a vehicle body frame in FIG. 1;

FIG. 3 is a perspective view of a seat rail in FIG. 1 and FIG. 2 viewed obliquely from the right rear;

FIG. 4 is a perspective view of the seat rail in FIG. 3 viewed from a position lower than the view point in FIG. 3;

FIG. 5 is a plan view of the seat rail shown in FIG. 3;

FIG. 6 is a left side view of the seat rail shown in FIG. 3;

FIG. 7 is a front view of the seat rail shown in FIG. 3;

FIG. 8 is a bottom view of the seat rail shown in FIG. 3;

FIG. 9(a) is a cross-sectional view taken along the line A-A in FIG. 8;

FIG. 9(b) is a cross-sectional view taken along the line B-B in FIG. 8;

FIG. 9(c) is a cross-sectional view taken along the line C-C in FIG. 8;

FIG. 10 is an enlarged perspective view of a connecting portion of a first connecting portion and a second connecting portion with respect to the wall portion or a first flange portion; and

FIG. 11 is an enlarged perspective view of a connecting portion of a third connecting portion and a fourth connecting portion with respect to the wall portion.

### DETAILED DESCRIPTION OF THE PREFERRED EMBODIMENTS

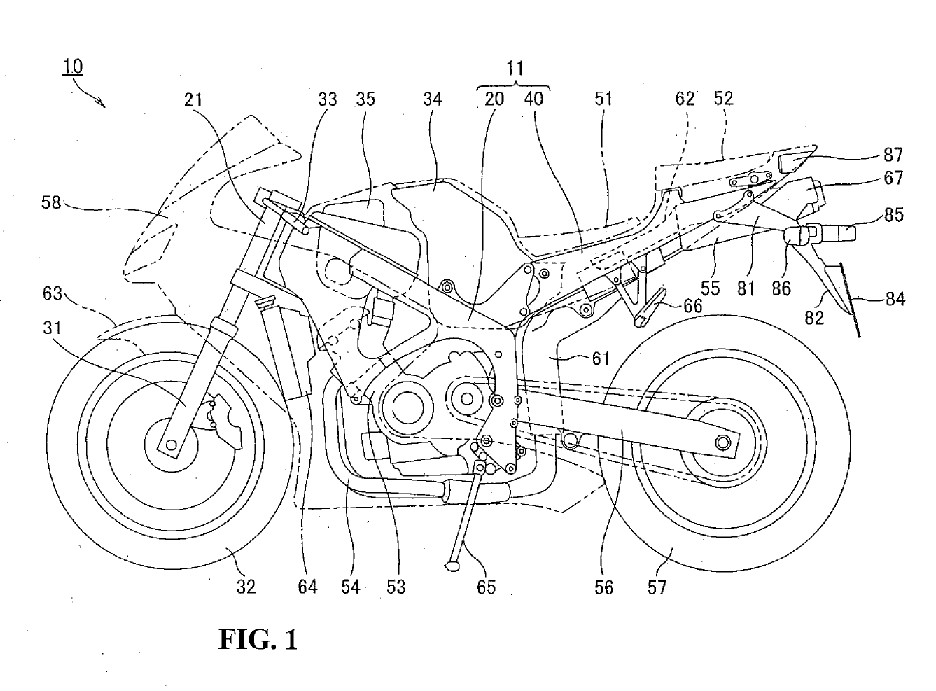

Referring now to the drawings, a seat rail structure of a motorcycle according to an embodiment of the present invention will be described. FIG. 1 is a left side view showing a motorcycle 10 according to an embodiment of the present invention. The directions used in the following description are based on FIG. 1, with the vertical direction of a vehicle body corresponding to the vertical direction of FIG. 1, the lateral direction of the vehicle body corresponding to the depth direction of a sheet plane of FIG. 1, and the fore-and-aft direction of the vehicle body corresponding to the lateral direction of the sheet plane of FIG. 1.

The motorcycle 10 includes a vehicle body frame 20 of a twin spar type extending in the fore-and-aft direction. A head pipe 21 is provided at the front side of the vehicle body frame 20. A front fork 31 extends downwardly and is attached to the head pipe 21 with a handle 33 being connected to the upper side thereof. A front wheel 32 is attached to the lower side of the front fork 31. A seat rail 40 is attached to the rear side of the vehicle body frame 20 so as to extend further from a rear end portion rearwardly of the vehicle body. A front seat 51 on which a driver sits and a rear seat 52 on which a passenger sits are attached on the upper side of the seat rail 40. The seat rail 40 serves as a rear frame which supports the front seat 51 and the rear seat 52.

The vehicle body frame 20 and the seat rail 40 constitute a vehicle body 11. The vehicle body 11 is entirely covered by a cowl 58 (shown by an imaginary line in FIG. 1).

The vehicle body frame 20 includes a fuel tank 34 and an air chamber 35 arranged on the front side of the fuel tank 34 attached to the upper portion thereof.

Arranged in a space of the vehicle body frame 20 is a four-cycle engine 53 with an exhaust pipe 54 being connected to an exhaust port positioned on a front portion of the engine 53. The exhaust pipe 54 is a metal pipe extending rearwardly from the exhaust port of the engine 53 through below the engine 53 to the rearward end of the vehicle body frame 20, extending upwardly from the rear end thereof along the vehicle body frame 20, and extending from the upper end thereof along the seat rail 40. Attached at the terminal end portion of the exhaust pipe 54 is a muffler 55. The muffler 55 is arranged between side wall portions 100L, 100R, described later in detail, of the seat rail 40 in the cross-vehicle direction.

The exhaust pipe 54 is covered by a heat-insulating tube 61. The upper portion of the muffler 55 is covered by a heat-insulating panel 62, and left and right rear portions of the muffler 55 are covered by protectors 67. The protectors 67 are protecting panels attached to a stay 81 provided for attaching a rear fender 82.

Swing arms 56 suspended by rear shock absorbers (not shown) are attached to the rear portion of the vehicle body frame 20 in the fore-and-aft direction of the vehicle body, and a rear wheel 57 is attached to rear end portions of the swing arms 56.

In FIG. 1, a front fender 63 is provided together with a radiator 64, a stand 65, a passenger step 66, a number plate 84, a license plate lamp 85, a rear winker 86 and a tail lamp 87.

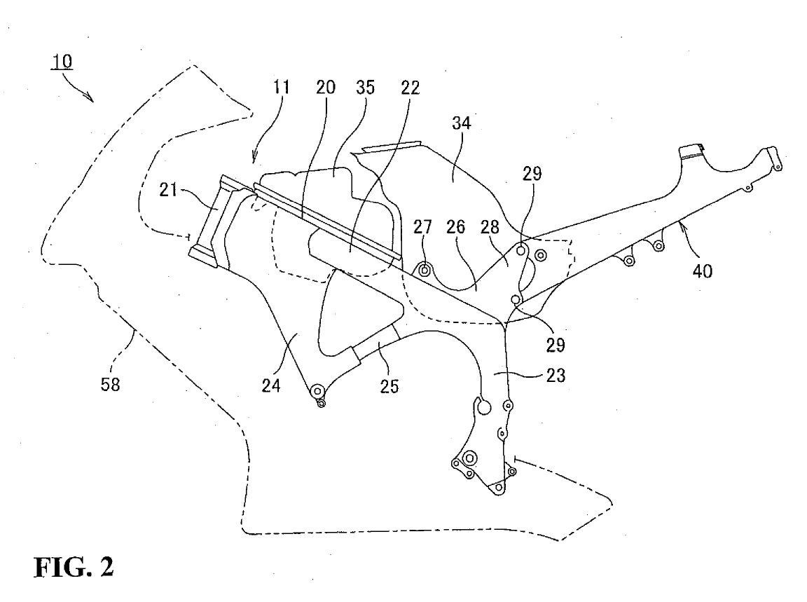

FIG. 2 is a left side view showing the vehicle body frame 20 in FIG. 1.

The vehicle body frame 20 includes the head pipe 21, left and right main frames 22, 22 extending rearwardly from the head pipe 21, left and right center frames 23, 23 (only the left one is shown in FIG. 2, hereinafter) extending downwardly from rear ends of the main frames 22, 22, left and right down frames 24, 24 extending rearwardly and downwardly from front portions of the head pipe 21 and the main frames 22, 22. Left and right upper frames 25, 25 extend from lower ends of the down frames 24, 24 toward the rear of the main frames 22, 22 with a plurality of cross members, not shown. Part or the entire frame members are cast members.

The left and right main frames 22, 22 are provided with left and right pivot plates 26, 26 which extend upwardly from rear upper portions thereof. The left and right pivot plates 26, 26 are formed with fuel tank supporting portions 27, 27 at the front portions thereof, and with seat rail mounting portions 28, 28 at the rear portions thereof. The fuel tank supporting portions 27, 27 and the seat rail mounting portions 28, 28 are formed with through holes penetrating therethrough in the cross-vehicle direction. The seat rail 40, described later in detail, is attached to the seat rail mounting portions 28, 28 via a plurality of bolts 29. The seat rail 40 extends rearwardly from the rear upper portion of the vehicle body frame 20.

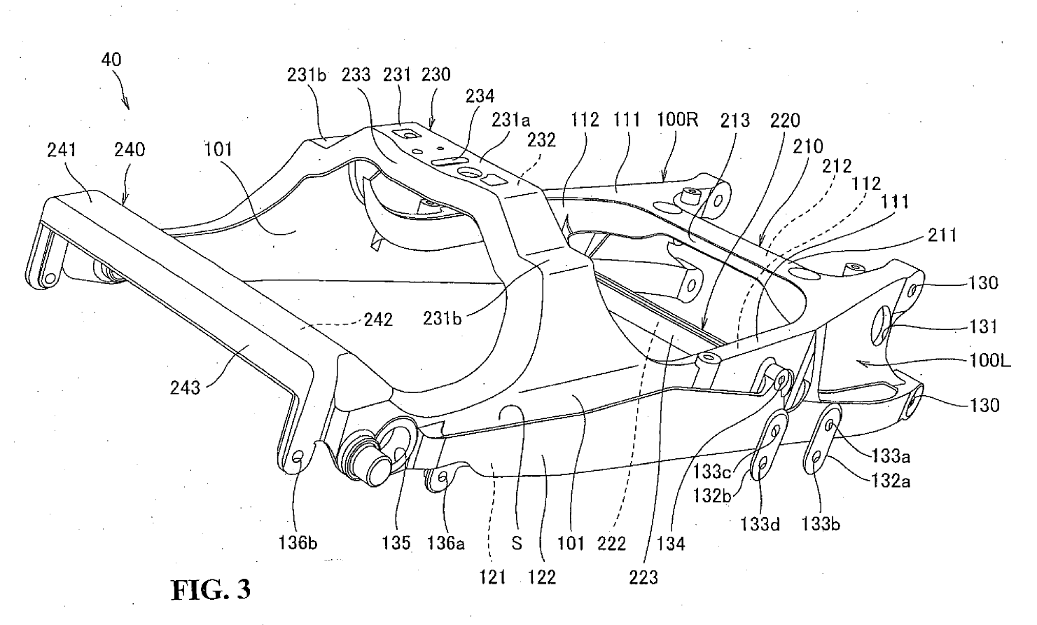

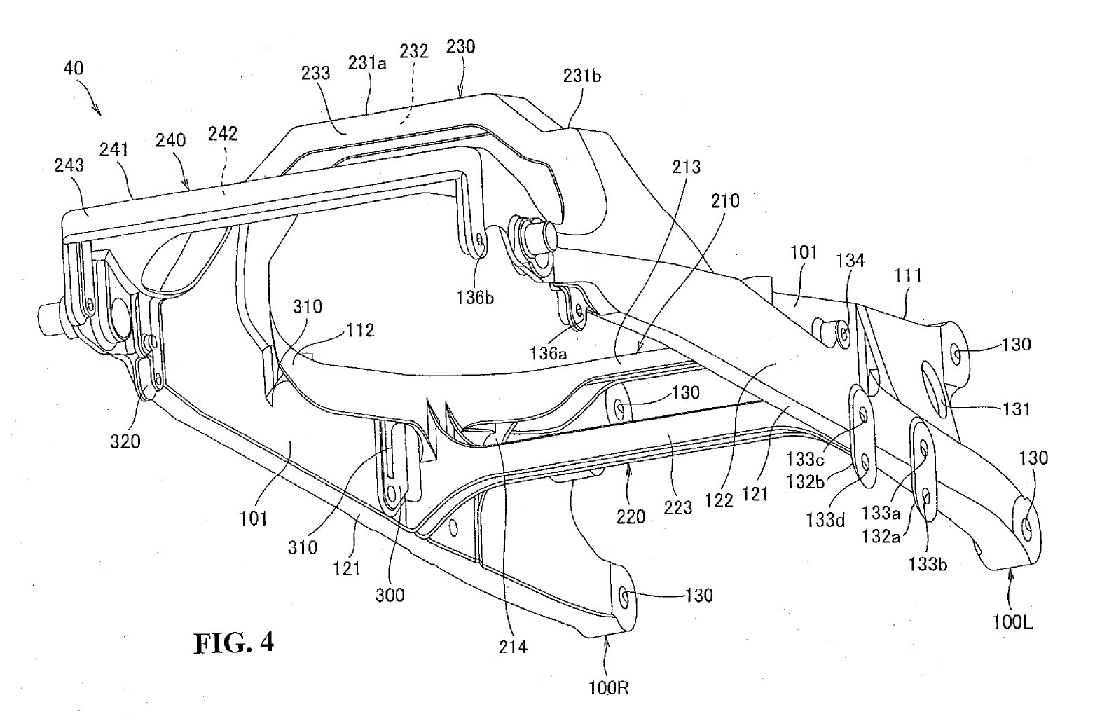

FIG. 3 to FIG. 8 show a simple body of the seat rail 40 in FIG. 1 and FIG. 2. The right side of the seat rail 40 shown in FIGS. 4 to 8 corresponds to the front side of the vehicle body on the sheet plane in FIG. 3.

As shown in FIGS. 3 and 4, the seat rail 40 is provided with the pair of left and right side wall portions 100L and 100R extending in the fore-and-aft direction of the vehicle body. The pair of left and right side wall portions 100L and 100R are connected by connecting portions (a first connecting portion 210, a second connecting portion 220, a third connecting portion 230, and a fourth connecting portion 240 in sequence from the front of the vehicle body). The seat rail 40 is integrally formed of magnesium alloy by die casting, described later in detail.

The side wall portions 100L and 100R are formed to be lateral symmetry. The configuration described about one of the side wall portions 100L is equivalent to the configuration of the side wall portion 100R.

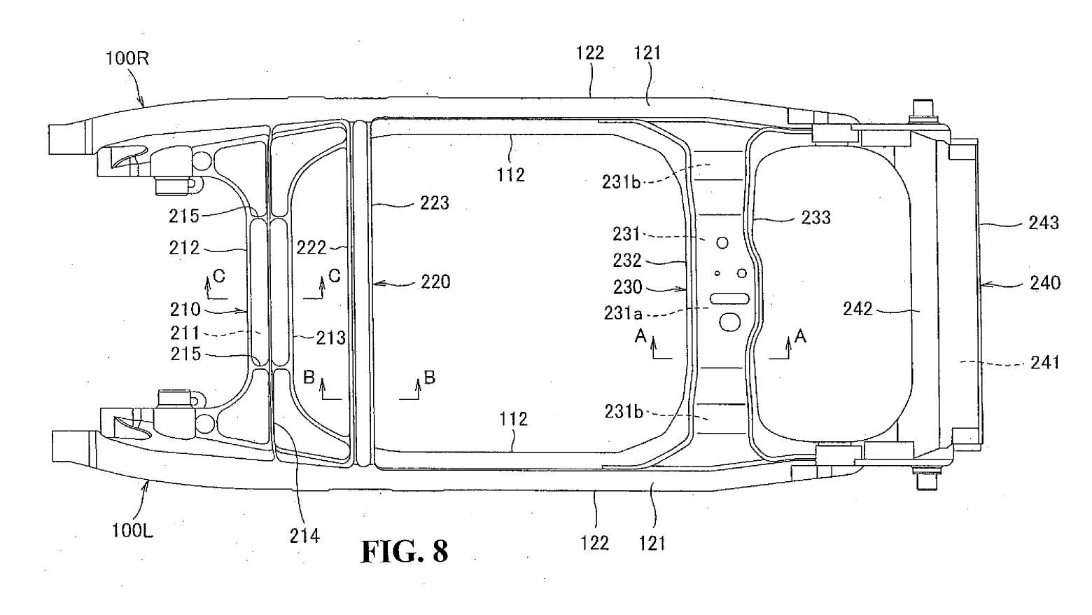

The side wall portions 100L and 100R each include a wall portion 101 (see FIGS. 3, 5 and 6) extending upright in the vertical direction, an upper flange portion 111 (see FIGS. 3, 5 and 6) positioned at an upper end portion of the wall portion 101, and a lower flange portion 121 (see FIGS. 4 and 8) positioned at the lower end portion of the wall portion 101.

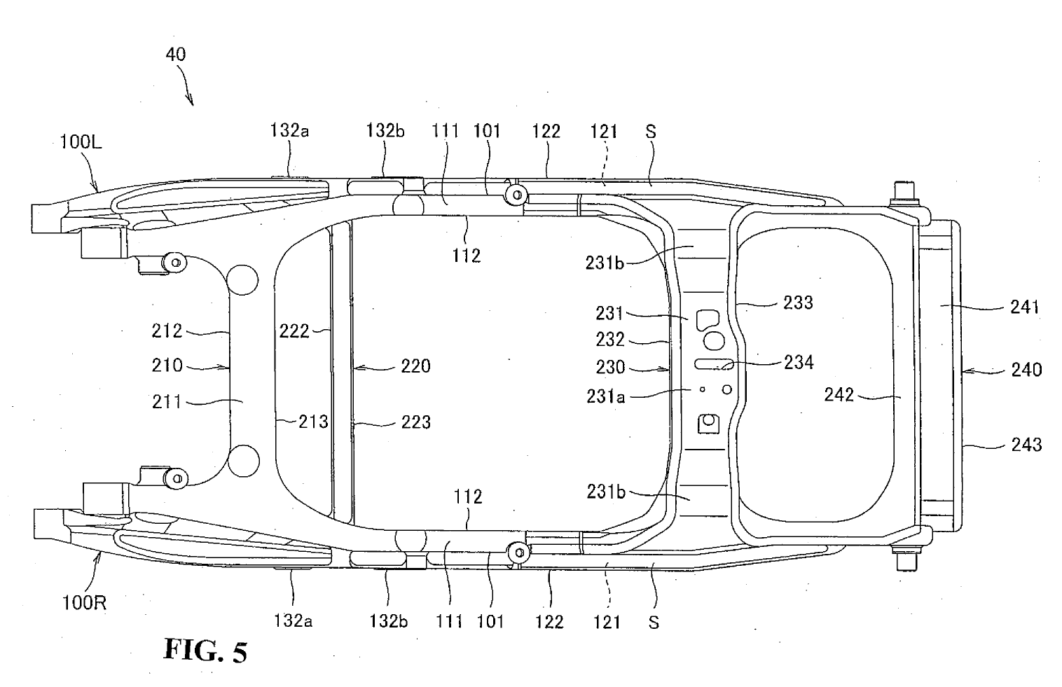

As shown in FIGS. 3 and 5, the upper flange portion 111 extends inwardly of the seat rail 40 in the lateral direction from the entire portion of the wall portion 101 in the longitudinal direction (fore-and-aft direction). As shown in FIGS. 3 and 4, a first flange portion 112 extends downwardly of the seat rail 40 from the distal end portion of the upper flange portion 111. In other words, when the side wall portions 100L and 100R are cut in the fore-and-aft direction of the vehicle body, the cross-sectional shape is a substantially angular C-shape having an opening on the lower side and being formed by the wall portion 101, the upper flange portion 111 and the first flange portion 112.

As shown in FIGS. 4 and 8, the lower flange portion 121 extends outwardly of the seat rail 40 in the lateral direction from the entire portion of the wall portion 101 in the longitudinal direction. As shown in FIGS. 4 and 8, a second flange portion 122 extends upwardly of the seat rail 40 from the distal end portion of the lower flange portion 121. In other words, when the side wall portions 100L and 100R are cut in the fore-and-aft direction of the vehicle body, the cross-sectional shape is a substantially angular C-shape having an opening on the upper side and being formed by the wall portion 101, the lower flange portion 121 and the second flange portion 122.

The wall portion 101, the upper flange portion 111, the first flange portion 112, the lower flange portion 121 and the second flange portion 122 are formed to have a thickness of at least 1.8 to 2.2 mm, portions required to have strength or rigidity are increased in thickness as needed, and a space S is provided between the first flange portion 112 and the wall portion 101 and between the second flange portion 122 and the wall portion 101, so that the weight reduction is achieved and the coefficient of the cross section of the side wall portion 100L is increased in comparison with the case in which the side wall portions 100L and 100R are formed into a solid shape, thereby securing the strength with respect to the bending and tensile load.

The reason why the minimum thickness of the respective portions is set to 1.8 to 2.2 mm is to allow a smooth flow of magnesium as a material at the time of die casting and prevent an easy generation of mold cavities (voids) in the interior of the molded seat rail 40. Therefore, the thickness can be selected as needed for the optimum performance depending on the outer dimensions and the strength of the seat rail 40.

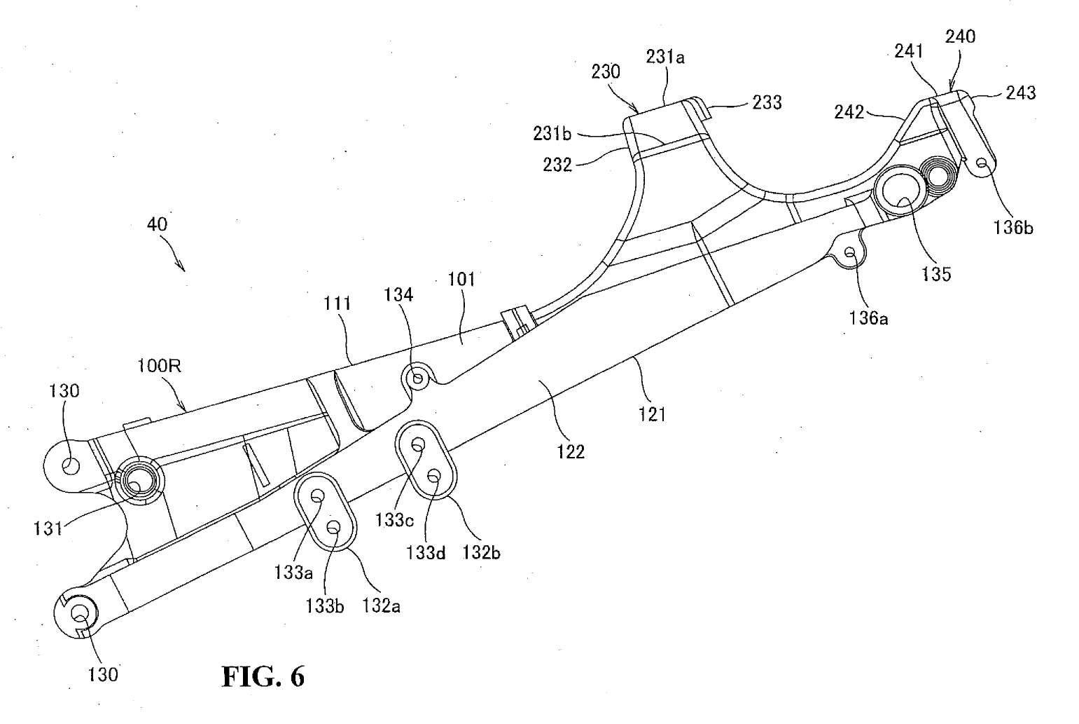

The front end portions of the side wall portions 100L and 100R are formed in the shape bifurcated in the vertical direction as shown in FIG. 6 (left side in FIG. 6 corresponds to the front side). The bifurcated portions are formed with mounting holes 130, 130 penetrating therethrough in the lateral direction. The mounting holes 130, 130 are adapted to be attached to the seat rail mounting portions 28 of the pivot plates 26, 26 with the bolts 29.

At the front end portions, the proximal portions of the bifurcation are formed with mounting holes 131 penetrating therethrough in the lateral direction for mounting the fuel tank 34.

As shown in FIGS. 3 and 6, two mounting portions (front mounting portion 132a and rear mounting portion 132b) projecting from the second flange portion 122 further toward the left side of the vehicle body (the near side of the sheet plane of FIG. 6, the cross-vehicle direction) are formed at the front of the center of the second flange portion 122. The front mounting portion 132a and the rear mounting portion 132b project from the lower ends of the side wall portions 100L and 100R (the lower end of the lower flange portion 121) further downwardly by about 50 mm.

The front mounting portion 132a is formed with two mounting holes (an upper mounting hole 133a and a lower mounting hole 133b). The rear mounting portion 132b is also formed with two mounting holes (an upper mounting hole 133c and a lower mounting hole 133d). The mounting holes 133a to 133d are adapted to attach the passenger step 66, a break reservoir tank (not shown) and the heat-insulating tube 61 or the like. As shown in FIG. 6, a mounting hole 134 for attaching a cowl is formed at an obliquely upper rear position of the rear mounting hole 132b (obliquely right rear in FIG. 6).

The side wall portions 100L and 100R are also formed with mounting holes 135 at rear portions on the side surfaces thereof for mounting the muffler 55 so as to penetrate therethrough in the lateral direction. Mounting holes 136a, 136b for mounting the stay 81 are formed on the left and right sides of the mounting holes 135 so as to penetrate therethrough in the lateral direction.

Subsequently, the first connecting portion 210, the second connecting portion 220, the third connecting portion 230 and the fourth connecting portion 240 will be described. The seat rail 40 in this embodiment includes four connecting portions. However, four or more connecting portions may be provided according to the strength of the seat rail 40 or, on the contrary, less than four connecting members may also be applicable.

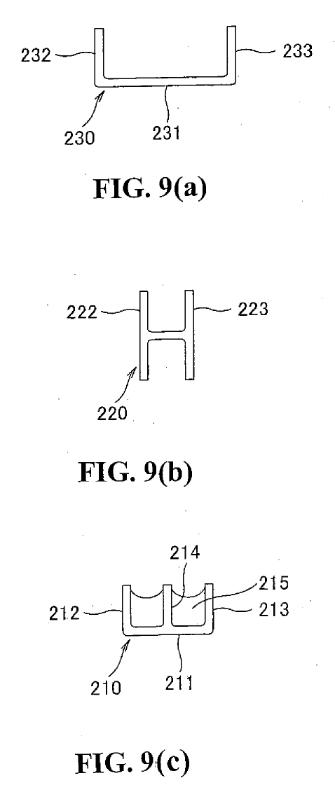

As shown in FIGS. 3 and 5, the first connecting portion 210 is formed to connect the first flange portions 112 of the side wall portions 100L and 100R. As shown in FIGS. 8 and 9(c), the interior of the first connecting portion 210 is hollow. More specifically, the cross-sectional shape of the first connecting portion 210 cut in the cross-vehicle direction is a substantially angular C-shape having an opening on the lower side as shown in FIG. 9(c), and includes an upper flat portion 211, a front wall portion 212 an a rear wall portion 213.

The first connecting portion 210 of the upper planar portion 211 is connected so as to be flush with the upper planar portions of the upper flange portions 111 of the side wall portions 100L and 100R as shown in FIG. 3.

The first flange portion 112 extending from the rear side to the front side and the rear wall portion 213 of the first connecting portion 210 are connected via a gentle curved surface as shown in FIG. 3. In the same manner, the first flange portion 112 extending from the front side to the rear side and the front wall portion 212 of the first connecting portion 210 are connected with a gentle curved surface.

The center portions in the widthwise direction of the front wall portion 212 and the rear wall portion 213 are formed to be shorter in height in comparison with both ends thereof, so as not to interfere with the components on the vehicle body side to which the seat rail 40 is attached.

The upper planar portion 211, the front wall portion 212, and the rear wall portion 213 have a minimum thickness of 1.8 to 2.2 mm like the upper flange portion 111 and the first flange portion 112, so that a weight reduction is achieved in comparison with the first connecting portion 210 the interior of which is solid. In addition, it is formed to a shape which allows the smooth flow of magnesium at the time of molding and prevents an easy generation of mold cavities in the interior of the first connecting portion 210.

As shown in FIGS. 8 and 9(c), a single rib 214 extends in the vertical direction along the longitudinal direction (the widthwise direction of the seat rail 40) of the first connecting portion 210 in the hollow interior of the first connecting portion 210. As shown in FIG. 8, two ribs 215 extend in the fore-and-aft direction of the seat rail 40 and are formed at a distance in the hollow interior of the first connecting portion 210. With the provision of the ribs 214, 215, the flexural strength and the tensile strength of the first connecting portion 210 are improved. The number of ribs 214, 215 may be selected as needed.

As shown in FIG. 3, the second connecting portion 220 is positioned at an obliquely lower rear side of the first connecting portion 210, and is formed to connect the wall portions 101 of the side wall portions 100L and 100R. The cross-sectional shape of the second connecting portion 220 cut in the cross-vehicle direction is a substantially H-shape having an opening on the upper side and lower side as shown in FIG. 9(b), and includes a front wall portion 222 and a rear planar portion 223.

The plate portion which constitutes the substantially H-shaped cross section has a thickness of 1.8 to 2.2 mm, so that a weight reduction is achieved in comparison with the second connecting portion 220 molded to be solid in the interior thereof, a smooth flow of magnesium is ensured at the time of molding, and the generation of molding cavities in the interior of the second connecting portion 220 is prevented.

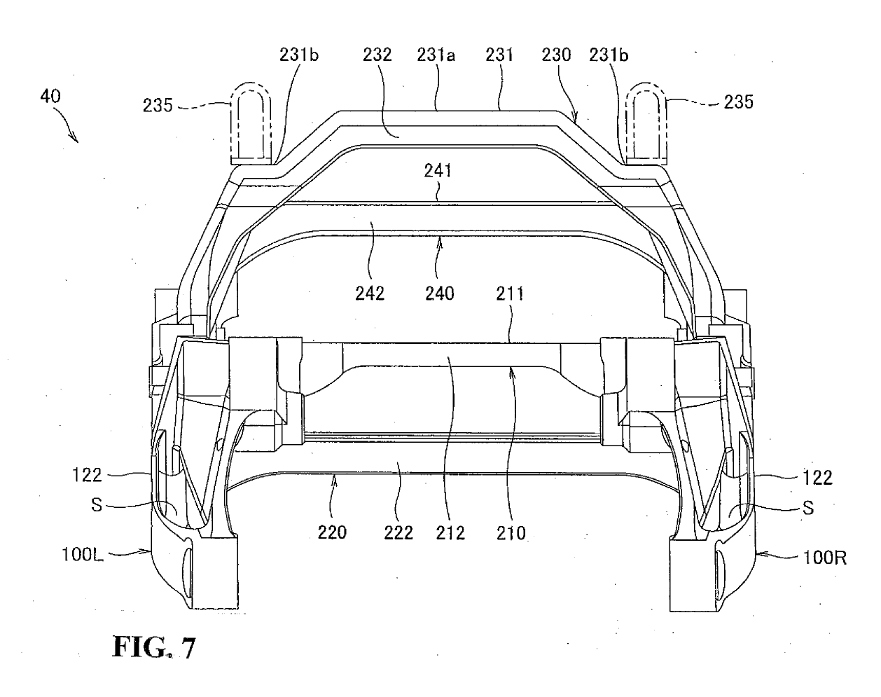

As shown in FIG. 3, the third connecting portion 230 is positioned behind the second connecting portion 220 and above the first connecting portion 210 and the second connecting portion 220. As shown in FIG. 7, the third connecting portion 230 is formed to extend from the upper surface of the upper flange portion 111 upwardly and obliquely inwardly thereof (inwardly of the seat rail 40), and is formed to connect the upper flange portions 111 of the both side wall portions 100L and 100R in an arch shape (arcuate shape) protruding upwardly.

As shown in FIG. 9(a), the cross-sectional shape of the third connecting portion 230 cut in the cross-vehicle direction is formed into a substantially angular C-shape having an opening on the lower side and includes an upper planer portion 231, a front wall portion 232 and a rear wall portion 233 as shown in FIG. 3. The front wall portion 232 is continued (connected) to the first flange portions 112, 112 of the side wall portions 100L and 100R extending from the front side to the rear side in a twisted manner as shown in FIG. 3. On the other hand, the rear wall portion 233 is continued to the upper flange portions 111, 111 of the side wall portions 100L and 100R extends from the rear to the front side in a twisted manner as shown in FIG. 3.

As shown in FIGS. 3 and 7, the upper planer portion 231 includes a first horizontal planer portion 231a positioned at the center, and two second horizontal planer portions 231b, 231b positioned on both sides of the first horizontal planer portion 231a below the level thereof when viewed from the front side of the seat rail 40. The first horizontal planer portion 231a is adapted to place the rear seat 52 thereon, and includes a plurality of mounting holes 234 for mounting the rear seat 52 formed thereon. The two second horizontal planer portions 231b, 231b are formed with mounting members 235 for fixing the rear seat 52 as shown by double-dashed chain lines in FIG. 7. The mounting members 235 may be formed integrally with the seat rail 40, and may be configured as separate mounting fixtures.

The upper planer portion 231, the front wall portion 232 and the rear wall portion 233 have a minimum thickness of 1.8 to 2.2 mm like the upper flange portion 111 and the first flange portion 112, and is configured to achieve a weight reduction in comparison with the third connecting portion 230 with the interior being formed to be solid. In addition, it is formed to a shape which allows a smooth flow of magnesium at the time of molding and prevents an easy generation of mold cavities in the interior of the third connecting portion 230.

As shown in FIG. 3, the fourth connecting portion 240 is positioned behind the third connecting portion 230, and is formed to connect the wall portions 101, 101 of the side wall portions 100L and 100R respectively. The cross-sectional shape of the fourth connecting portion 240 cut in the cross-vehicle direction is substantially an angular C-shape having the opening on the lower side and as shown in FIG. 3, includes an upper planer portion 241, a front side wall portion 242 and a rear side wall portion 243.

The upper planer portion 241 is formed to be positioned below the level of the first horizontal planer portion 231a and the second planer portion 231b of the third connecting portion 230 and above the upper planar portion 211 of the first connecting portion 210 as shown in FIGS. 3 and 7.

The front side wall portion 242 is continued (connected) to the upper flange portions 111, 111 of the side wall portions 100L and 100K extending from the front side to the rear side as shown in FIG. 3. More specifically, the front wall portion 242 extends from the front end of the upper planer portion 241 obliquely toward the lower front in a direction in which the aforementioned substantially angular C-shaped opening is widened. On the other hand, the rear wall portion 243 extends substantially downwardly in the vertical direction from the rear end of the upper planer portion 241, and constitutes the rear end portion of the seat rail 40 as shown in FIG. 4.

The upper planer portion 241, the front side wall portion 242 and the rear side wall portion 243 have a minimum thickness of 1.8 to 2.2 mm like the upper flange portion 111 and the first flange portion 112, and are configured to achieve a weight reduction in comparison with the fourth connecting portion 240 with the interior being formed to be solid. In addition, it is formed in a shape which allows the smooth flow of magnesium at the time of molding and prevents the easy generation of mold cavities in the interior of the fourth connecting portion 240.

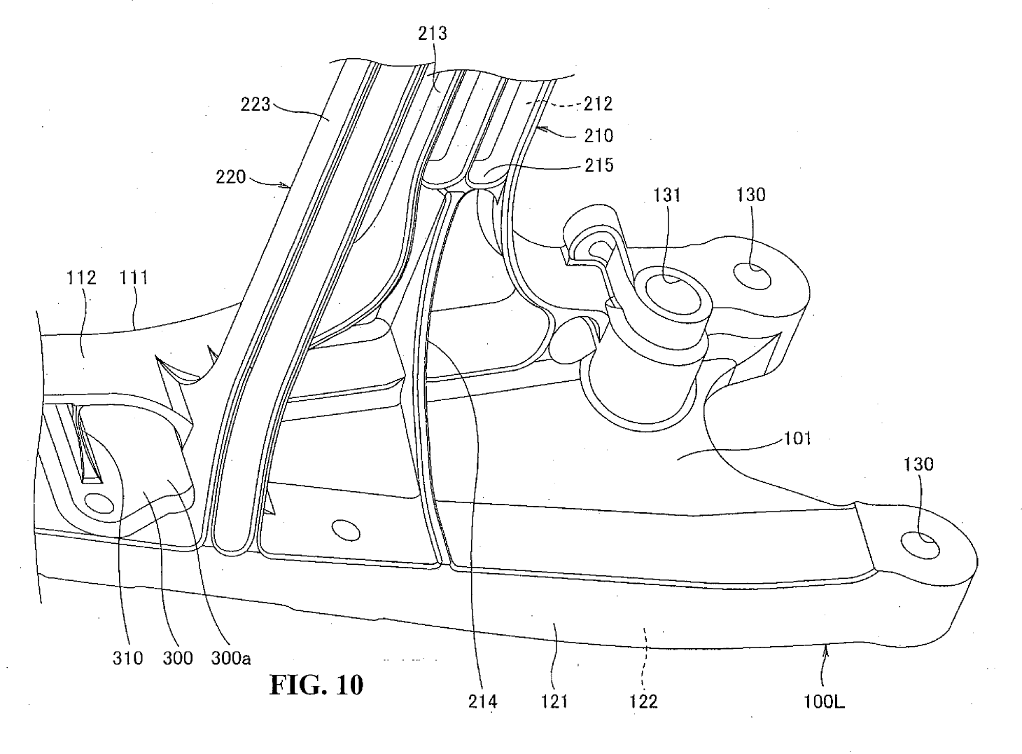

FIG. 10 is an enlarged perspective view showing a connecting portion of the first connecting portion 210 and the second connecting portion 220 with respect to the wall portion 101 or the first flange portion 112.

The rib 214 of the first connecting portion 210 is connected to the first flange portion 112 at the end portion thereof, and extends further downwardly to the lower flange portion 121. In other words, the rib 214 is formed to extend over five members of the upper planar portion 211 of the first connecting portion 210, the first flange portion 112, the upper flange portion 111, the wall portion 101 and the lower flange portion 121 so as to connect these members with respect to each other as shown in FIG. 10.

On the other hand, as shown in FIG. 10, formed on the back side of the second connecting portion 220 is a shoulder 300 projecting inwardly of the seat rail 40. The shoulder 300 is formed to extend over four members of the rear wall portion 223 of the second connecting portion 220, the upper flange portion 111, the wall portion 101 and the lower flange portion 121 so as to connect these members with respect to each other.

The shoulder 300 is formed with a rib 310 on an inner surface 300a thereof so as to connect three members of first flange portion 112, the upper flange portion 111 and the inner surface 300a.

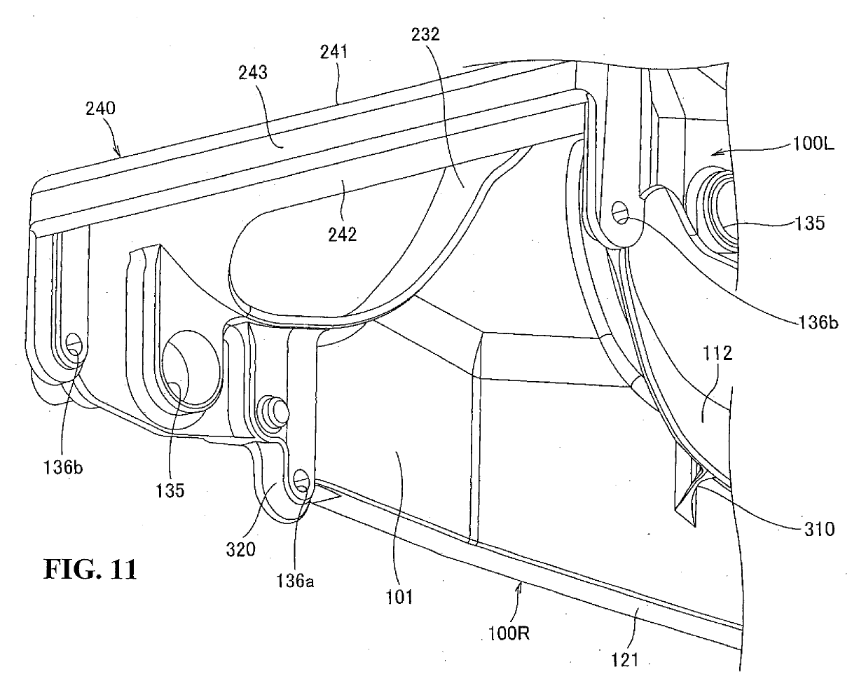

FIG. 11 is an enlarged perspective view showing a connecting portion of the third connecting portion 230 and the fourth connecting portion 240 with respect to the wall portion 101.

Formed on the front side of the third connecting portion 230 is the rib 310 which connects the first flange portion 112, the upper flange portion 111 and the wall portion 101 as shown in FIG. 11.

Formed between the third connecting portion 230 and the fourth connecting portion 240 is a shoulder 320 projecting from the wall portion 101 inwardly of the seat rail 40 as shown in FIG. 11. The shoulder 320 is formed to connect (join) the upper flange portion 111 which corresponds to a starting point of the rear wall portion 233 of the third connecting portion 230, a starting point of the front wall portion 242 of the fourth connecting portion 240, the wall portion 101 and the lower flange portion 121.

The seat rail 40 having the configuration as described above is formed to have corners with an R-shape as needed as shown in FIG. 3, so that burrs or cracks are prevented from being formed at these corners when die casting.

A coating for preventing corrosion is applied on the surface of the seat rail 40, with a plurality of coating layers being formed thereon. The number of coating layers depends on the number of times of application on the seat rail 40 (the number of times of coating processes).

Furthermore, by forming the seat rail 40 to have the side wall portions 100L and 100R and the connecting portions 210 to 240 into the shape as described above, the metal die for die casting may be configured basically to have upper and lower halves.

Magnesium alloy, which is a material of the seat rail 40, will now be described.

The seat rail 40 is integrally formed of magnesium alloy and, more specifically, formed integrally by die casting. The type of the magnesium alloy is AM50A (ASTM standard, Al:4.4 to 5.4 wt %, Mn:0.26 to 0.6 wt %, Zn:0.22 wt % max., Si:0.10 wt % max., Cu:0.010 wt % max., Ni:0.002 wt % max., Fe:0.004 wt % max., others:0.02 wt %), or AM60B (ASTM standard, Al:5.5 to 6.5 wt %, M:0.24 to 0.6 wt %, Zn:0.22 wt % max., Si:0.10 wt % max., Cu:0.010 wt % max., Ni:0.002wt % max., Fe:0.005 wt % max., others:0.02 wt %), and is further added with rare earths (Ce, La, Nd, etc.) by 0.2 to 0.5 wt %.

The material AM50A or AM60B has a characteristic of being highly ductile with high impact resistance, and is used for handles or the like of the motor vehicle. The corrosion resistance is improved by adding rare earths.

By adding rare earths to the material of the seat rail 40, that is, aforementioned AM50A or AM60B by 2.0 to 5.0 wt %, the strength at elevated temperature is improved in addition to the corrosion resistance.

According to the seat rail structure of the motorcycle in this embodiment of the present invention, the seat rail 40 includes the pair of left and right side wall portions 100L and 100R extending rearwardly from the main frame 22 and four connecting portions, that is, the first connecting portion 210, the second connecting portion 220, the third connecting portion 230, and the fourth connecting portion 240, which connect the side wall portions 100L and 100R. The seat rail 40 is integrally formed by casting the side wall portions 100L and 100R and these four connecting portions. Therefore, it is not necessary to assemble the seat rail 40 with tightening members or the like. Thus, the productivity of the seat rail 40 is improved. Since the entire part of the seat rail 40 is formed of a magnesium alloy, a weight reduction of the vehicle body is achieved. Since the magnesium alloy is superior as a vibration absorbing mechanism, vibrations from the engine or the road surface during the travel are absorbed, so that a comfortable driving is realized.

Since the connection of the third connecting portion 230 is located above the level of the upper surface of the upper flange portion 111 of the side wall portions 100L and 100R, interference between the rear wheel 57 and the third connecting portion 230 of the seat rail 40 is avoided when the rear wheel 57 arranged below the seat rail 40 moves up and down. Since the internal space of the inner side of the seat rail 40 is widened, interference between the components to be attached to the motorcycle 10 side, particularly, the muffler 55 and the seat rail 40 is avoided.

Furthermore, since the first connecting portion 210, the second connecting portion 220, the third connecting portion 230 and the fourth connecting portion 240 are formed to have substantially an angular C-shape or a substantially H-shape in cross section, and the four connecting portions are composed of combinations of the plate shaped portions having a thickness of 1.8 mm to 2.2 mm, the weights of the respective connecting portions 210, 220, 230, 240 are reduced. Since the coefficients of cross section of the respective connecting portions 210, 220, 230, 240 are increased, sufficient strength and rigidity against bending or tensile strength of the connecting portion are secured. Consequently, the strength and rigidity of the entire seat rail 40 are improved.

The upper end portions of the side wall portions 100L and 100R are formed with the upper flange portions 111 extending inwardly of the seat rail 40 along the longitudinal direction of the side wall portions 100L and 100R and the first flange portions 112 extending downwardly from the distal end portions of the upper flange portions 111, and the lower end portions of the side wall portions 100L and 100R are formed with the lower flange portions 121 extending outwardly of the seat rail 40 along the longitudinal direction of the side wall portions 100L and 100R and the second flange portions 122 extending upward from the distal end portions of the lower flange portions 121. Therefore, in comparison with the structure in which the left and right side wall portions 100L and 100R are solid, a weight reduction of the side wall portions 100L and 100R is achieved. Since the coefficients of cross section of the side wall portions 100L and 100R are increased, a sufficient strength and rigidity are secured for bending or tensile load of the side wall portions 100L and 100R. Consequently, the strength and rigidity of the entire seat rail 40 are improved.

Since the rib 214 is provided along the center of substantially angular C-shaped cross section of the first connecting portion 210 so as to extend over the five members of the upper planar portion 211 of the first connecting portion 210, the first flange portion 112, the upper flange portion 111, the wall portion 101 and the lower flange portion 121 so as to be connected to each other, the flexural strength and rigidity of the first connecting portion 210 are further improved. Consequently, the strength of the entire seat rail 40 is further improved.

Since the shoulders 320 are provided so as to connect at least one of the upper flange portions 111 and the lower flange portions 121 with the wall portions 101 of the side wall portions 100L and 100R, the strength and rigidity of the connecting portions between the upper flange portions 111 or the lower flange portions 121 and the wall portions 101 are improved. Consequently the strength and rigidity of the entire seat rail 40 are improved.

On the other hand, since the material of the magnesium alloy is AM50A or AM60B, and the rare earths are added to the AM50A or AM60B by 0.2 wt % to 0.5 wt %, the corrosion resistance of the seat rail 40 is improved. Consequently, the number of the processes to apply surface treatment (for example, chemical conversion or electro deposition) for corrosion resistance on the surface of the seat rail 40 may be reduced. Therefore, the number of steps for manufacturing the seat rail 40 is reduced in comparison with the related art.

Since the material of the magnesium alloy is AM50A or AM60B, and the rare earths are added to the AM50A or AM60B by 2.0 wt % to 5.0 wt %, the corrosion resistance is improved, and the strength at elevated temperature is improved. The rare earths improve toughness required for the frame in comparison with other high temperature strength improving additives (Ca, Sr, etc.).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A seat rail structure of a motorcycle comprising:
a main frame and a seat rail formed of magnesium alloy for securing to the main frame,
wherein the seat rail includes a pair of left and right side wall portions extending rearwardly from the main frame, and a plurality of connecting portions formed into a substantially angular C-shape in cross section or into a substantially H-shape in cross section for connecting the left and right side wall portions, at least part of the connecting portions are connected at a level flush with or above the upper surface of the side wall portions, and the side wall portions and the connecting portions are integrally formed by die casting.

2. The seat rail structure of a motorcycle according to claim 1, wherein that the side wall portion is formed at the upper end thereof with an upper flange portion extending inwardly in the direction of the width of the seat rail along a longitudinal direction of the side wall portion and having a first flange portion extending downwardly from the distal end thereof, and at the lower end thereof with a lower flange portion extending outwardly in the direction of the width of the seat rail along the longitudinal direction of the side wall portion and having a second flange portion extending upwardly from the distal end thereof.

3. The seat rail structure of a motorcycle according to claim 1, and further including a first rib extends in a longitudinal direction at the center of the substantially angular C-shaped cross section or the substantially H-shaped cross section of the connecting portions.

4. The seat rail structure of a motorcycle according to claim 2, and further including a first rib extends in the longitudinal direction at the center of the substantially angular C-shaped cross section or the substantially H-shaped cross section of the connecting portions.

5. The seat real structure of a motorcycle according to claim 2, and further including a second rib for connecting at least one of the upper flange portion and the lower flange portion with the side wall portion.

6. The seat real structure of a motorcycle according to claim 3, and further including a second rib for connecting at least one of the upper flange portion and the lower flange portion with the side wall portion.

7. The seat real structure of a motorcycle according to claim 4, and further including a second rib for connecting at least one of the upper flange portion and the lower flange portion with the side wall portion.

8. The seat rail structure of a motorcycle according to claim 1, wherein that the magnesium alloy is AM50A or AM60B, and AM50A or AM60B includes rare earths added by 0.2 wt % to 0.5 wt %.

9. The seat rail structure of a motorcycle according to claim 2, wherein that the magnesium alloy is AM50A or AM60B, and AM50A or AM60B includes rare earths added by 0.2 wt % to 0.5 wt %.

10. The seat rail structure of a motorcycle according to claim 3, wherein that the magnesium alloy is AM50A or AM60B, and AM50A or AM60B includes rare earths added by 0.2 wt % to 0.5 wt %.

11. The seat rail structure of a motorcycle according to claim 4, wherein that the magnesium alloy is AM50A or AM60B, and AM50A or AM60B includes rare earths added by 0.2 wt % to 0.5 wt %.

12. The seat rail structure of a motorcycle according to claim 5, wherein that the magnesium alloy is AM50A or AM60B, and AM50A or AM60B includes rare earths added by 0.2 wt % to 0.5 wt %.

13. The seat rail structure of a motorcycle according to claim 1, wherein that the magnesium alloy is AM50A or AM60B, and AM50A or AM60B includes rare earths added by 2.0 wt % to 5.0 wt %.

14. The seat rail structure of a motorcycle according to claim 2, wherein that the magnesium alloy is AM50A or AM60B, and AM50A or AM60B includes rare earths added by 2.0 wt % to 5.0 wt %.

15. The seat rail structure of a motorcycle according to claim 3, wherein that the magnesium alloy is AM50A or AM60B, and AM50A or AM60B includes rare earths added by 2.0 wt % to 5.0 wt %.

16. The seat rail structure of a motorcycle according to claim 4, wherein that the magnesium alloy is AM50A or AM60B, and AM50A or AM60B includes rare earths added by 2.0 wt % to 5.0 wt %.

17. The seat rail structure of a motorcycle according to claim 5, wherein that the magnesium alloy is AM50A or AM60B, and AM50A or AM60B includes rare earths added by 2.0 wt % to 5.0 wt %.

18. A seat rail structure adapted to be used with a motorcycle comprising:
a main frame and a seat rail formed of magnesium alloy for securing to the main frame,
said seat rail includes:
a pair of left and right side wall portions extending rearwardly from the main frame; and
a plurality of connecting portions formed into a substantially angular C-shape in cross section or into a substantially H-shape in cross section for connecting the left and right side wall portions;
wherein at least part of the connecting portions are connected at a level flush with or above the upper surface of the side wall portions;
said side wall portions and the connecting portions being integrally formed by die casting.

19. The seat rail structure adapted to be used with a motorcycle according to claim 18, wherein that the side wall portion is formed at the upper end thereof with an upper flange portion extending inwardly in the direction of the width of the seat rail along a longitudinal direction of the side wall portion and having a first flange portion extending downwardly from the distal end thereof and at the lower end thereof with a lower flange portion extending outwardly in the direction of the width of the seat rail along the longitudinal direction of the side wall portion and having a second flange portion extending upwardly from the distal end thereof.

20. The seat rail structure adapted to be used with a motorcycle according to claim 18, and further including a first rib extends in a longitudinal direction at the center of the substantially angular C-shaped cross section or the substantially H-shaped cross section of the connecting portions.
